(19) United States
(12) Patent Application Publication
(10) Pub. No.: US 2009/0056123 A1
(43) Pub. Date: Mar. 5, 2009

(54) Friction lock design for adjustable pump head to allow for 360° rotation

(75) Inventors: David L. Phillips, Santa Ana, CA (US); Ashfaq Mir, Fountain Valley, CA (US); Chris McDonald, Yorba Linda, CA (US); Doug Gastineau, Costa Mesa, CA (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: ITT MANUFACTURING ENTERPRISES INC.

(21) Appl. No.: 11/897,257

(22) Filed: Aug. 28, 2007

(51) Int. Cl. B23P 17/00; F04B 17/00

(52) U.S. Cl. 29/888; 417/321

(57) ABSTRACT

A method and apparatus are provided for coupling a pump head (1) and a motor housing (4) of a pump together so that a rotational positioning ring (2) of the pump head (1) frictionally engages a snap ring (5) of the motor housing (4) so as to allow for 360° rotation of the pump head (1) in relation to the motor housing (4), where the orientation of the pump head (1) and the motor housing (4) are adjustable in relation to one another so as to allow an end user to set the orientation of the pump in any configuration. The positioning ring (2) has a plurality of members separated by slots for radially flexing when the rotational positioning ring (2) is axially coupled over the snap ring (5) of the motor housing (4). Each of the plurality of members has a rim so as to form a raised edge for frictionally engaging a corresponding raised edge of the snap ring (5) of the motor housing (4).

### BACKGROUND OF THE INVENTION

1. Technical Field

The present invention relates to a pump; and more particularly to a method and apparatus for coupling together a pump head and a motor housing of a pump.

2. Description of Related Art

During the course of installing a pump in some equipment or apparatus, due to space constraints or possibly for some other reason it would be desirable, or possibly even necessary, to be able to rotate the pump head in relation to the pump housing in order to best fit the pump in a given installation. For example, in order to install one known pump, typically port fittings or hosing couplings of the pump head must be coupled to suitable hosing in the equipment or apparatus, and one or more brackets of the motor housing must be securely fastened to some structure in the equipment or apparatus, such as a housing or corresponding bracket. However, current pump designs typically require that screws be removed in order to allow for pump head rotation in relation to the motor housing. In addition, the majority of pump designs also only allow for only two positions that are 180° apart from one another—essentially, if the pump head needs to be rotated, then the installer can only turn the pump head upside down.

Because of this, the current pump designs are limited to either right side up or upside down orientations. In addition, removal of the screws usually requires the end user or installer to have tools available and also allows for loss of parts and the possibility of dislodging components upon reassembly. Typically, most pumps are secured either to a motor or a housing with screws which limits the amount of rotational movement one can effect. In the case where two screws are used, the amount of rotational movement would typically be limited to 180° of rotation. These limitations also require more accessories, such as port fittings with various geometries to accommodate hose installation.

In view of the aforementioned, there is a need in the industry for a technique that has a positive lock design, where the end user can simply rotate pump head a full 360° rotation, in incremental angles, and then start using the pump in the application. This would allows the user to simply pick the pump up and adjust the angle of the head, especially where no tools or extra port fittings would be required.

In addition, a patent search was conducted on the subject matter of the instant invention. The following is a brief summary of the patents developed therein: U.S. Pat. No. 6,764,284 discloses a pump mounting using a sanitary flange clamp 72 for coupling a motor 12 to a pump 14. U.S. Pat. No. 6,276,908 discloses a latching mechanism for use with pumps used in marine environments having a cap 64, 164 for detachably coupling to and enclosing a pump housing 62, 162. U.S. Pat. No. 5,538,406 discloses a removable cartridge type pump for live well bait tanks for coupling to a side wall or transom 11 of a boat as shown in FIG. 5. See FIGS. 6 and 15 which show a housing portion 12 for detachably and rotatably coupling to a bayonet mounted motor portion 15. U.S. Pat. No. 5,470,207 discloses an air conditioning compressor unit 12 and mounting apparatus 14 having mounting rings 16, 18, as shown in FIG. 1. Other United States patents developed in the search include the following: U.S. Pat. Nos. 2,784,673; 3,398,695; 3,491,696; 4,306,841 and 4,904,166, which are of general interest.

### SUMMARY OF THE INVENTION

The present invention provides a new and unique method and apparatus for coupling together a pump head and a motor housing of a pump so that a rotational positioning ring of the pump head frictionally engages a snap ring of the motor housing so as to allow for 360° rotation of the pump head in relation to the motor housing, where the orientation of the pump head and the motor housing are adjustable in relation to one another so as to allow an end user to set the orientation of the pump in a desired configuration.

In one embodiment, the positioning ring may include a plurality of locating notches for snapping over a corresponding plurality of tabs on the snap ring. In this embodiment, the locating notches on the rotational positioning ring snap over and are held in place by locating the same on the tabs that may be spaced incrementally for rotational security of the pump head.

In an alternative embodiment, the positioning ring may also include a plurality of members separated by slots for radially flexing when the rotational positioning ring is axially coupled over the snap ring of the motor housing. Each of the plurality of members may have a rim so as to form a raised edge for frictionally engaging a corresponding raised edge of the snap ring of the motor housing.

In either embodiment, the positioning ring may include an inner surface with a circumferential groove for adapting a compression O-ring for sealing the pump head and motor housing, as well as for maintaining the friction along with the snap features to ensure the pump head does not rotate needlessly or unexpectedly in relation to the motor housing.

The apparatus according to the present invention may take the form of a pump that features such a pump head for coupling to such a motor housing so that such a rotational positioning ring of the pump head frictionally engages such a snap ring of the motor housing so as to allow for the 360° rotation of the pump head in relation to the motor housing, the orientation of the pump head and the motor housing being adjustable in relation to one another so as to allow such an end user to set the orientation of the pump in such a desired configuration.

In effect, by utilizing the positive lock design according to the present invention, the end user or installer of the pump can simply rotate the pump head a full 360° rotation, in incremental angles, and then start using the pump in the application. This allows the end user to simply pick the pump up and adjust the angle of the pump head during installation. No tools or extra port fittings are required like that is the prior art.

Possible applications include, but are not limited to, the beverage industry, industrial applications, RV applications, military applications, marine applications and other fluid applications.

### BRIEF DESCRIPTION OF THE DRAWING

The drawing includes the following Figures, which are not necessarily drawn to scale:

FIGS. 1a and 1b show perspective views of one embodiment of a pump having a pump head and a motor housing for coupling together according to the present invention.

FIG. 2a shows a cross-sectional view of the pump shown in FIG. 1 having locating notches of the pump head snapped over tabs of the motor housing when the pump head is coupled to the motor housing according to the present invention.

FIG. 2b shows a partial enlarged view of a particular locating notch snapped over a particular tab shown in FIG. 2a according to the present invention.

FIG. 3 shows a partial enlarged cross-sectional view of a radial sealing ring arranged on a snap ring of the motor housing arranged in relation to a positioning ring of the pump housing for sealing the same when the pump head is coupled to the motor housing according to the present invention.

FIG. 4 shows a perspective view of an alternative embodiment of a pump having a pump head and a motor housing for coupling together according to the present invention.

FIGS. 5a, 5b, 5c and 5d show perspective views of the pump shown in FIG. 4 having the pump head rotated in relation to the pump housing at four different angles, including 0°, 90°, 105° and 285° respectively, according to the present invention.

### BEST MODE FOR CARRYING OUT THE INVENTION

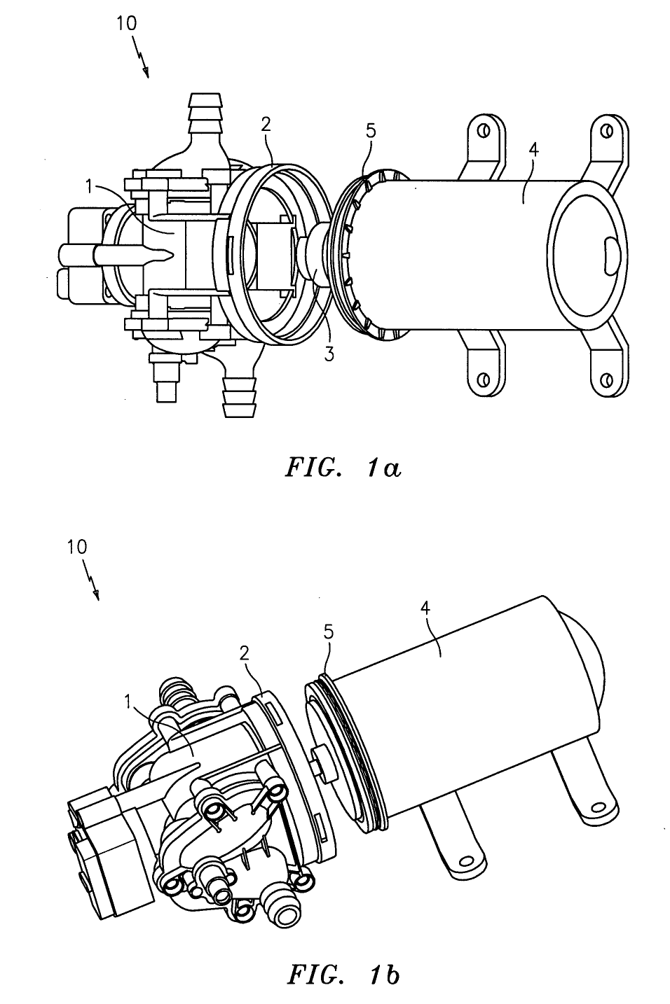

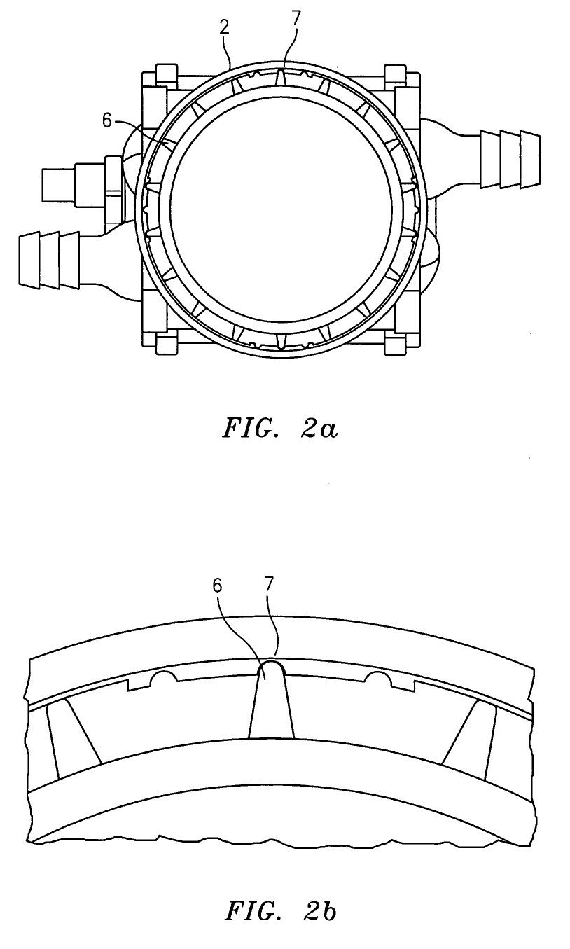

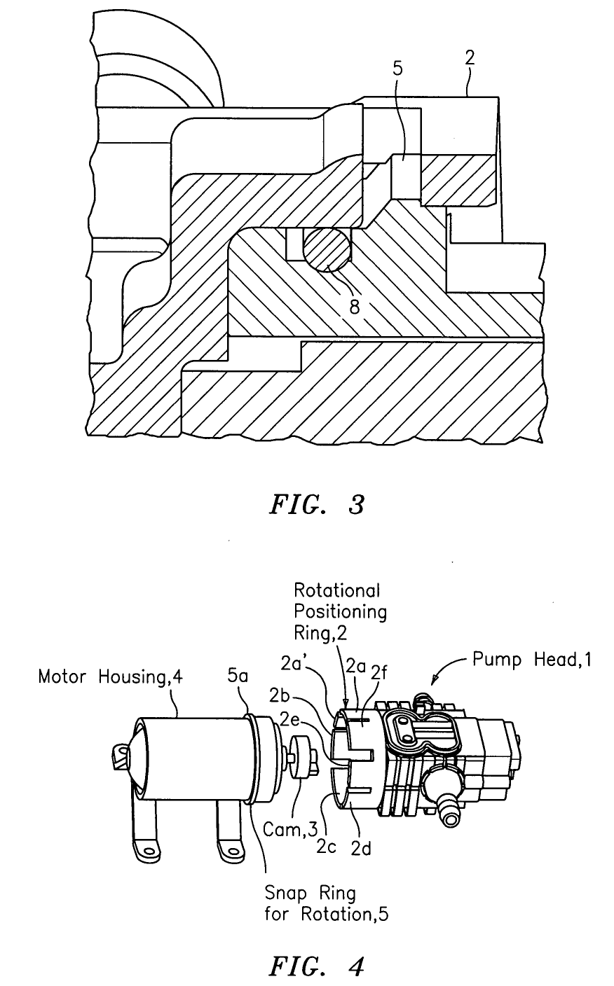

FIGS. 1a-5d show, by way of example, a new and unique method and apparatus for coupling a pump head (1) and a motor housing (4) of a pump generally indicated as 10 together so that a rotational positioning ring (2) of the pump head (1) frictionally engages a snap ring (5) of the motor housing (4) so as to allow for 360° rotation of the pump head (1) in relation to the motor housing (4), where the orientation of the pump head (1) and the motor housing (4) are adjustable in relation to one another so as to allow an end user to set the orientation of the pump in a desired configuration, according to the present invention. In effect, the pump head (1) may be rotated in relation to the motor housing (4) at a multitude of different incremental angles in the range of 0° and 360° rotation. The scope of the invention is not intended to be limited to the type or kind of pump; and embodiments are envisioned using the application in relation to many different types or kinds of pumps, including those now known or later developed in the future.

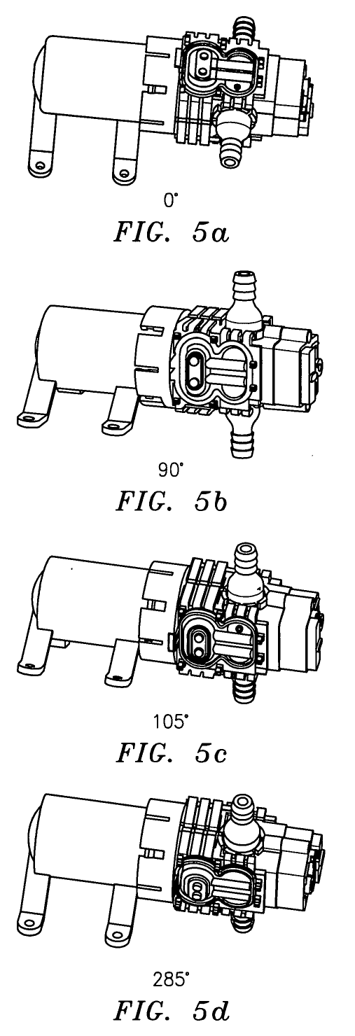

In one embodiment shown in FIGS. 1a through 3, the positioning ring (2) may include a plurality of locating notches (7) for snapping over a corresponding plurality of tabs (6) on the snap ring (5). As shown, the positioning ring (2) includes four locating notches (7) that are arranged about the circumference of the ring (2) at about 90° intervals, and the snap ring (5) includes 18 tabs (6) that are arranged about the circumference of the snap ring (5) at about 20° intervals. In operation, the locating notches (7) on the rotational positioning ring (2) snap over and are held in place by locating the same on the tabs (6) that are spaced incrementally for rotational security of the pump head (1). The scope of the invention is not intended to be limited to the number or the interval of spacing of the locating notches (7) on the rotational positioning ring (2) or the tabs (6) of the positioning ring (2). Embodiments are envisioned within the scope and spirit of the invention using a different number or a different interval of spacing of the locating notches (7) on the rotational positioning ring (2) or the tabs (6) of the positioning ring (2). Moreover, the scope of the invention is not intended to be limited to the use of notches and tabs for frictionally engaging such a rotational positioning ring (2) of such a pump head (1) in relation to such a snap ring (5) of such a motor housing (4) so as to allow for 360° rotation of the pump head (1) in relation to the motor housing (4). For example, the scope of the invention is intended to other techniques for frictionally engaging the same, including the technique shown and described below in relation to FIGS. 4 through 5d, as well as other techniques for frictionally engaging the same either now known or later developed in the future.

For example, in an alternative embodiment shown in FIGS. 4 through 5d, the positioning ring (2) may include a plurality of members separated by slots for radially flexing when the rotational positioning ring (2) is axially coupled over the snap ring (5) of the motor housing (4). As shown, the plurality of members includes 6 members (2a, 2b, 2c, 2d, 2e, 2f). Each of the plurality of members may have a rim (e.g. 2a′) so as to form a raised edge for frictionally engaging a corresponding raised edge 5a of the snap ring (5) of the motor housing (4). The scope of the invention is not intended to be limited to the number of the flexing members or the interval of spacing thereof. Embodiments are envisioned within the scope and spirit of the invention using a different number of flexing members or a different interval of spacing thereof.

FIGS. 5a, 5b, 5c and 5d show the pump shown in FIG. 4 having the pump head rotated in relation to the pump housing at four different angles, including 0°, 90°, 105° and 285° respectively, according to the present invention. The rotational angles shown in FIGS. 5a-5d are shown by way of example; and scope of the invention is intended to include the pump head being capable to rotate in relation to the pump housing at substantially any angle in the range of 0° and 360°.

In either embodiment, the positioning ring (2) may include an inner surface with a circumferential groove for adapting a compression O-ring (8) for sealing the pump head and motor housing, as well as for maintaining the friction along with the snap features to ensure the pump head (1) does not rotate needlessly or unexpectedly in relation to the motor housing (4). In operation, the rotational positioning ring (2) snaps over the snap ring (5) on the motor housing (4) and is sealed from the elements and water by the radial seal (8).

As shown in FIGS. 1a, 1b, the pump head (1) contains the rotational positioning ring (2). In operation, the ring is snapped onto the snap ring (5) on the motor housing (4) aligning the cam (3) inside the pump head (1). Once in place, the method includes rotating the pump head (1) at any angle between 0° and 360° on the motor housing (4) to a desired orientation, allowing an end user to set the orientation of the pump in desired orientation.

The apparatus may take the form of a new and unique pump 10 having the pump head (1) for coupling together to the motor housing (4) so that the rotational positioning ring (2) of the pump head (1) frictionally engages the snap ring (5) of the motor housing (4) so as to allow for 360° rotation of the pump head (1) in relation to the motor housing (4), where the orientation of the pump head (1) and the motor housing (4) are adjustable in relation to one another so as to allow an end user to set the orientation of the pump in any configuration.

It is also noteworthy that the pump 10 includes many other features that do not form part of the underlying invention and thus are not described in detail herein, including but not limited to the cam (3) for allowing a motor in the motor housing (4) to drive a pump in the pump head (2), various port fittings, the bracket, etc.

### THE SCOPE OF THE INVENTION

It should be understood that, unless stated otherwise herein, any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein without departing from the spirit and scope of the present invention.

1. A method comprising:
coupling together a pump head (1) and a motor housing (4) of a pump so that a rotational positioning ring (2) of the pump head (1) frictionally engages a snap ring (5) of the motor housing (4) so as to allow for 360° rotation of the pump head (1) in relation to the motor housing (4); and
adjusting the orientation of the pump head (1) and the motor housing (4) in relation to one another so as to allow an end user to set the orientation of the pump in a desired configuration.

2. A method according to claim 1, wherein the positioning ring (2) has a plurality of members separated by slots for radially flexing when the rotational positioning ring (2) is axially coupled over the snap ring (5) of the motor housing (4).

3. A method according to claim 1, wherein each of the plurality of members has a rim so as to form a raised edge for frictionally engaging a corresponding raised edge of the snap ring (5) of the motor housing (4).

4. A method according to claim 1, wherein the positioning ring (2) has an inner surface with a circumferential groove for adapting a compression O-ring for sealing.

5. A method according to claim 1, wherein the positioning ring (2) has a plurality of locating notches (7) for snapping over a corresponding plurality of tabs (6) on the snap ring (5).

6. A method according to claim 5, wherein the locating notches (7) on the rotational positioning ring (2) snap over and are held in place by locating on the tabs (6) spaced incrementally for rotational security of the pump head (1).

7. A method according to claim 1, wherein the pump head (1) may be rotated in relation to the motor housing (4) at a multitude of different incremental angles in the range of 0° and 360° rotation.

8. A method according to claim 1, wherein the pump head (1) may be rotated in relation to the motor housing (4) at substantially any angle in the range of 0° and 360° rotation.

9. A method according to claim 1, wherein the method includes adapting a compression O-ring (8) between the rotational positioning ring (2) and the motor housing (4) that seals the pump head (1) and motor housing (4), or maintains friction to ensure the pump head (1) does not rotate needlessly or unexpectedly in relation to the motor housing (4), or some combination thereof.

10. A pump comprising:
a pump head (1) for coupling to a motor housing (4) so that a rotational positioning ring (2) of the pump head (1) frictionally engages a snap ring (5) of the motor housing (4) so as to allow for 360° rotation of the pump head (1) in relation to the motor housing (4), the orientation of the pump head (1) and the motor housing (4) being adjustable in relation to one another so as to allow an end user to set the orientation of the pump in a desired configuration.

11. A pump according to claim 10, wherein the positioning ring (2) has a plurality of members separated by slots for radially flexing when the rotational positioning ring (2) is axially coupled over the snap ring (5) of the motor housing (4).

12. A pump according to claim 10, wherein each of the plurality of members has a rim so as to form a raised edge for frictionally engaging a corresponding raised edge of the snap ring (5) of the motor housing (4).

13. A pump according to claim 10, wherein the positioning ring (2) has an inner surface with a circumferential groove for adapting a compression O-ring for sealing.

14. A pump according to claim 10, wherein the positioning ring (2) has a plurality of locating notches (7) for snapping over a corresponding plurality of tabs (6) on the snap ring (5).

15. A pump according to claim 14, wherein the locating notches (7) on the rotational positioning ring (2) snap over and are held in place by locating on the tabs (6) spaced incrementally for rotational security of the pump head (1).

16. A pump according to claim 10, wherein the pump head (1) may be rotated in relation to the motor housing (4) at a multitude of different angles in the range of 0° and 360° rotation.

17. A pump according to claim 10, wherein the pump head (1) may be rotated in relation to the motor housing (4) at substantially any angle in the range of 0° and 360° rotation.

18. A pump according to claim 10, wherein a compression O-ring (8) is adapted between the rotational positioning ring (2) and the motor housing (4) that seals the pump head (1) and motor housing (4), or maintains friction to ensure the pump head (1) does not rotate needlessly or unexpectedly in relation to the motor housing (4), or some combination thereof.
